(19) United States
(12) Patent Application Publication
(10) Pub. No.: US 2022/0309500 A1
(43) Pub. Date: Sep. 29, 2022

(54) HANDLING BULK FILE PROCESSING WHILE MAINTAIN FILE LEVEL CONSISTENCY

(71) Applicant: Oracle Financial Services Software Limited, Mumbai (IN)

(72) Inventors: Ramanathan Arunachalam, Bengaluru (IN); Belcy Thomas, Bangalore (IN); Anil Kumar Subramanian, Vignana Nagar Bangalore (IN); Deepika Venkatesan, Chennai (IN)

(73) Assignee: Oracle Financial Services Software Limited, Mumbai (IN)

(21) Appl. No.: 17/214,490

(22) Filed: Mar. 26, 2021

(51) Int. Cl. G06Q 20/40; G06F 16/23; G06F 16/22

(52) U.S. Cl. CPC G06Q 20/401; G06F 16/2386; G06F 16/2282

(57) ABSTRACT

Techniques for handling bulk file processing. One technique includes receiving a request to process transactions within a bulk file, consolidating the transactions into batches based on parameters used to define the transactions, processing a first set of exception validations for each of the batches, storing information for each of the batches that satisfies the first set of exception validations within a set of tables, processing, using JMS Queues and the set of tables, a second set of exception validations for each of the transactions within the batches that satisfy the first set of exception validations, collating, using a timer job and the set of tables, each of the transactions into subsequent batches based on whether each of the transactions satisfies or does not satisfies the second set of exception validations, and accounting each of the transactions in the subsequent batches that satisfy the second set of exception validations.

### FIELD OF THE INVENTION

The present disclosure relates generally to bulk file processing, and more particularly, to techniques for handling bulk file processing more efficiently in payments using Java Message Service (JMS) queues while maintaining file level consistency.

### BACKGROUND

A bulk payment is a bank system that allows a payor to make multiple debit payments to a bulk list, e.g., salary payment. A bulk list is a list of credit accounts or beneficiaries you intend to pay from a single debit account. The transaction shows as a single debit for the total amount of the payment on the bank statement. For a bulk payment, a user sends money through different ways including: Bank transfers (ACH), Paypal or other financial institutions, credit card and debit card payments (mainly for refunds), and the like. Bulk payment processing leads to faster payments and satisfied merchants. The most common way to send a bulk payment is with a bank wire transfer. This has different names depending on where the user is in the world. In the Eurozone, transfers are called SEPA Credit Transfers, in the US they are known as ACH (Automated Clearing House) transactions, and in the UK, they are mainly called Faster Payments or BACS. The ACH (Automated Clearing House) is a networked banking system for the exchange of money. An API (application programming interface) into ACH is how developers might connect to a bank programmatically to execute ACH transactions (also known as “direct deposit”). This requires the bank to provide API access into their ACH system and draw from the client's account. An ACH API may also require custom proxy connections to that individual bank. The advantage of modern bank transfers lies in speed. Payments are virtually instant.

To initiate a bulk transfer, a user needs a tool that allows them to send a large number of payments simultaneously. This can be achieved with software like the API, file importer, or File Exchange Gateway. Most banks offer these platforms, but it can be hard to get access and many tools have limitations. An alternative is to partner with a company that specializes in bulk payments such as PayPal, which offers a bulk payments service with their own API and file importer to facilitate the process. If a user is a business that processes a high volume of “on account” or “lay-by” sales, it's almost impossible to pay off each debtor individually. It eats up precious time the user could be spending on the business. Bulk payments allow the user to make multiple individual sales against a single entity in real-time. This enables retailers to pay off a customer's balance in bulk without having to go through each sale separately. Bulk payments cannot be made without a bulk list first. The bulk list is a pre-specified list of credit accounts or beneficiaries a user intends to pay from a single debit account. There are two types of bulk lists and bulk payments: Standard Domestic Bulk Payment and Bulk Inter Account Transfer (TAT). Standard Domestic Bulk Payment allows a business to make a standard domestic remittance to multiple recipients from a single debit account. An IAT bulk transaction allows a user to transfer funds to multiple credit accounts from a single debit account. Bulk Inter Account Transfers are often used to make international payments and is streamlined process that's not only faster but more reliable and secure than other methods. The advantages of bulk payments are its the fastest way to send money to multiple people, cost a user a lot less than sending individual payments, secure because it requires sophisticated security protocols, and saves hours of individual sales calculations which facilitates operations and streamlines finances.

### BRIEF SUMMARY

Techniques are provided (e.g., a method, a system, non-transitory computer-readable medium storing code or instructions executable by one or more processors) for handling bulk file processing more efficiently in payments using Java Message Service (JMS) queues while maintaining file level consistency.

In various embodiments, a method is provided that comprises: receiving, by a data processing system, a request to process transactions within a bulk file; consolidating, by the data processing system, the transactions into batches based on one or more parameters used to define the transactions; processing, by the data processing system at a batch level, a first set of exception validations for each of the batches to identify batches that satisfy or do not satisfy the first set of exception validations; storing, by the data processing system, information for each of the batches that satisfies the first set of exception validations within a set of tables, where the tables cascade from a file level to a batch level to an individual transaction level using common keys that reflect a hierarchy; processing, by the data processing system at an individual transaction level, a second set of exception validations for each of the transactions within the batches that satisfy the first set of exception validations in order to identify transactions that satisfy or do not satisfy the second set of exception validations, where Java Message Service (JMS) Queues implementing: (i) a Message-Driven Bean (MDB), and (ii) the set of tables, are used for the processing of the second set of exception validations at the individual transaction level; collating, by the data processing system, each of the transactions into subsequent batches based on whether each of the transactions satisfies or does not satisfies the second set of exception validations, where a timer job implementing the set of tables is used to collate each of the transactions into the subsequent batches; and accounting, by the data processing system at the individual transaction level, each of the transactions in the subsequent batches that satisfy the second set of exception validations.

In some embodiments, the one or more parameters are network, debit account, value date, transfer currency, charge account, or any combination thereof.

In some embodiments, the method further comprises: prior to processing the second set of exceptions validations, resolving, by the data processing system at the individual transaction level, a network associated with each of the transactions, wherein the JMS Queues implementing: (i) another MDB, and (ii) the set of tables, are used for the resolving the network at the individual transaction level; and collating, by the data processing system, each of the transactions into consequent batches based on the one or more parameters used to define the transactions, where another timer job implementing the set of tables is used to collate each of the transactions into the consequent batches, where the second set of exception validations are processed for each of the transactions within the consequent batches that satisfy the first set of exception validations.

In some embodiments, the set of tables comprise a first table, a second table, and a third table, wherein the first table provides a batch status for each of the batches, the second table provides a network status and validation status for each of the transactions, and the third table provides a batch status for each of the consequent batches.

In some embodiments, the JMS Queues implementing: (i) the another MDB, and (ii) the first table and the second table, are used for the resolving the network at the individual transaction level.

In some embodiments, the JMS Queues implementing: (i) the MDB, and (ii) the third table and the second table, are used for the processing of the second set of exception validations at the individual transaction level.

In some embodiments, the method further comprises rejecting, by the data processing system at the individual transaction level, each of the transactions in the subsequent batches that do not satisfy the second set of exception validations.

In various embodiments, a system is provided that includes one or more data processors and a non-transitory computer readable storage medium containing instructions which, when executed on the one or more data processors, cause the one or more data processors to perform part or all of one or more methods disclosed herein.

In various embodiments, a computer-program product is provided that is tangibly embodied in a non-transitory machine-readable storage medium and that includes instructions configured to cause one or more data processors to perform part or all of one or more methods disclosed herein.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

FIG. 1 is an illustration of a payment system in accordance with various embodiments.

FIGS. 2A, 2B, and 2C depict a swim lane diagram illustrating a process for bulk file accounting in accordance with various embodiments.

FIGS. 3A and 3B depict a swim lane diagram illustrating a process for individual transaction processing in accordance with various embodiments.

FIG. 4 depicts a flowchart illustrating a process for handling bulk file processing more efficiently in payments using JMS queues while maintaining file level consistency in accordance with various embodiments.

FIG. 5 depicts a simplified diagram of a distributed system for implementing various embodiments.

FIG. 6 is a simplified block diagram of one or more components of a system environment by which services provided by one or more components of an embodiment system may be offered as cloud services, in accordance with various embodiments.

FIG. 7 illustrates an example computer system that may be used to implement various embodiments.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

### Introduction

The following disclosure describes techniques for handling bulk file processing more efficiently in payments using JMS queues while maintaining file level consistency. As used herein, a “bulk file” is a data structure that allows a user to submit multiple data transactions (e.g., payment records) in a single file upload. Bulk file processing in the context of bulk payments has many unique processing requirements including funding blocks, currency conversion, accounting, future-dated warehouse handling, cut-offs and carry-forwards, validations, sanctions scanning, and message generation. Apart from these, the bulk files also have very high processing through-put requirements due to customer or clearing cut-off priorities. Take for example, where a corporate entity initiates bulk file processing of payment files for purposes of payroll to debit corporate accounts (file sizes typically run between 10,000 to 250,000 payments but could go higher, e.g., a million payments). The bulk file processing, utilizing CPU capabilities, typically includes receiving and parsing the bulk file, making sure mandatory validations for payments are clear, checking the balance available on a corporate account, blocking funds on the corporate account, performing currency conversion if necessary, scanning the entire payment record including the corporate account for sanctions, and final accounting and processing of payments.

However, this is very inefficient because each individual transaction is debiting the same corporate account and the processes are validating, checking, blocking, and scanning the same corporate account over and over wasting CPU power and time. On solution to address this is problem is to utilize batch processing in order to process all payment transactions within a bulk file in a single payment transaction. Complexity however arises in batch processing because each of the bulk file process steps have multiple requirements that have to be performed at the batch or individual transaction level. For example, a typically bulk file process for bulk payment may comprise: file reading and parsing <batch level>, batch level validations <batch level>, network resolution <individual transaction level>, batch segregation <batch level>, future dated warehouse movement <batch level>, amount block <batch level>, currency conversion <batch level>, transaction validations <individual transaction level>, sanctions scanning <individual transaction level>, cut off check and carry forwards <batch level>, accounting <batch level>, and message generation <individual transaction level>. As can be seen above, the processing switches from batch level to individual transaction level and then back to batch level multiple times. Thus, there is a need for being able to perform batch processing (batch level) interspersed with individual transaction or transaction processing (individual transaction level).

To address these problems, various embodiments provide techniques (e.g., systems, methods, computer program products storing code or instructions executable by one or more processors) for: (i) using JMS Queues each time the bulk file processing has to switch from the batch level to the individual transaction level, and (ii) using timer jobs to keep track of processing completion of individual transactions at each stage the bulk file processing has to revert from the individual transaction level to the batch level. Upon completion, the timer jobs collate the individual transactions and trigger the next stage of batch level processing. The timer jobs are individually configurable to suit the business needs to be implemented within the bulk file processing. The various embodiments provide further techniques for: (iii) using a lean set of tables to cater to various batch level and individual transaction level processing requirements. The set of tables are designed to avoid the risk of data proliferation, and thus data inconsistency. The tables of the set cascade from the bulk file level to the batch level to the individual transaction level using common keys that reflect the hierarchy. Each time the timer jobs operate to collate data from the previous individual transaction level to trigger the next batch level, the status control columns in these tables are used to control the flow. The JMS Queues utilize Message-Driven Beans (MDB), which are message listeners that can reliably consume messages from a queue or a subscription of a topic, and each JMS-MDB is designed for a specific individual transaction level process (e.g., network resolution or message generation). Moreover, each timer job is designed to keep track of the processing of the previous individual transaction level process and then triggers the next batch level process, The Java Persistence API (JPA) control is used for data integrity at each step, and the entire flow is orchestrated using the lean set of tables to maintain file level consistency. Advantageously, deploying both JMS Queues and timer jobs helps to achieve parallel execution of the work-load.

In one illustrative embodiment, a computer implemented method is provided for that comprises: receiving, by a data processing system, a request to process transactions within a bulk file; consolidating, by the data processing system, the transactions into batches based on one or more parameters used to define the transactions; processing, by the data processing system at a batch level, a first set of exception validations for each of the batches to identify batches that satisfy or do not satisfy the first set of exception validations; storing, by the data processing system, information for each of the batches that satisfies the first set of exception validations within a set of tables, where the tables cascade from a file level to a batch level to an individual transaction level using common keys that reflect a hierarchy; processing, by the data processing system at an individual transaction level, a second set of exception validations for each of the transactions within the batches that satisfy the first set of exception validations in order to identify transactions that satisfy or do not satisfy the second set of exception validations, where Java Message Service (JMS) Queues implementing: (i) a Message-Driven Bean (MDB), and (ii) the set of tables, are used for the processing of the second set of exception validations at the individual transaction level; collating, by the data processing system, each of the transactions into subsequent batches based on whether each of the transactions satisfies or does not satisfies the second set of exception validations, where a timer job implementing the set of tables is used to collate each of the transactions into the subsequent batches; and accounting, by the data processing system at the individual transaction level, each of the transactions in the subsequent batches that satisfy the second set of exception validations.

### Payment System

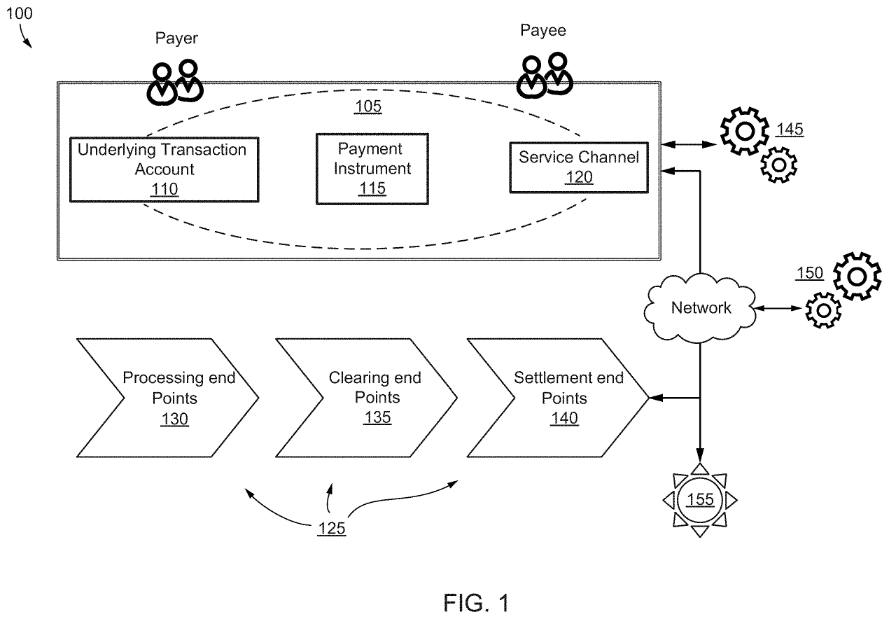

A payment system is a set of instruments, procedures and rules among participating institutions, including the operator of the system, used for the purposes of clearing and settling payment transactions. The payment system's infrastructure usually involves payments flowing through a “front end” that interacts with end users and a number of “back end” arrangements that process, clear and settle payments. FIG. 1 shows a payment system 100 comprising front-end arrangements 105 that initiate the payment from a payer to a payee. The front end arrangements 105 comprise the underlying transaction account 110, the payment instrument 115, and a service channel or access point 120. The underlying transaction account 110 (e.g., deposit transaction) represents the source of the funds (e.g., a corporate account). The payment instrument means a check, draft, money order, traveler's check, stored-value, or other instrument or order for the transmission or payment of money or monetary value, sold to one or more persons, whether or not that instrument or order is negotiable. The payment instrument 115 (e.g., cash, check, credit card) can vary across payment service providers (PSPs) and use cases. PSPs are third parties that help payees accept and facilitate payments. The PSPs include bank and nonbank entities such as PayPal, Due, Stripe, and the like. The service channel 120 (e.g., bank branch, automated teller machine (ATM), point-of-sale (POS) terminal, payment application) connects the payer/payee and the PSPs. The payment system 100 further comprises back-end arrangements 125 that focus on the specific steps or stages of the payment chain. The back-end arrangements comprise processing end points 130, clearing end points 135, and settlement end points 140. The processing end points 130 provide services such as authentication, authorization, fraud and compliance monitoring, fee calculation, etc. The clearing end points 135 provide services such as transmitting, reconciling and, in some cases, confirming transactions prior to settlement. The settlement end points 140 provide services such as transferring funds to discharge monetary obligations between parties (payer to a payee).

The payment system 100 may further comprise overlay systems 145, closed-loop systems 150, and external systems 155. The overlay systems 145 provide front-end services by using existing infrastructure to process and settle payments (e.g., ApplePay, Google Pay, PayPal). These systems link the front-end arrangements 105 to a user's credit card or bank account. The closed-loop systems 150 (e.g., Alipay, M-Pesa, WeChat Pay) provide front-end to back-end services, have back-end arrangements 125 largely proprietary to their respective firms, and do not interact with or depend much on the existing payment infrastructure. The external systems 155 provide external services that facilitate the services provided by back-end arrangements 125 such as an external currency exchange rate system, a demand deposit account (DDA) system (e.g., accounting system that hold funds in a bank account from which deposited funds can be withdrawn at any time, such as checking accounts), sanction system provides sanctions screening for customers and transactions to ensure compliance with various sanction policies, and external pricing systems that define prices for various services,

Bulk File Processing Using JMS Queues while Maintaining File Level Consistency

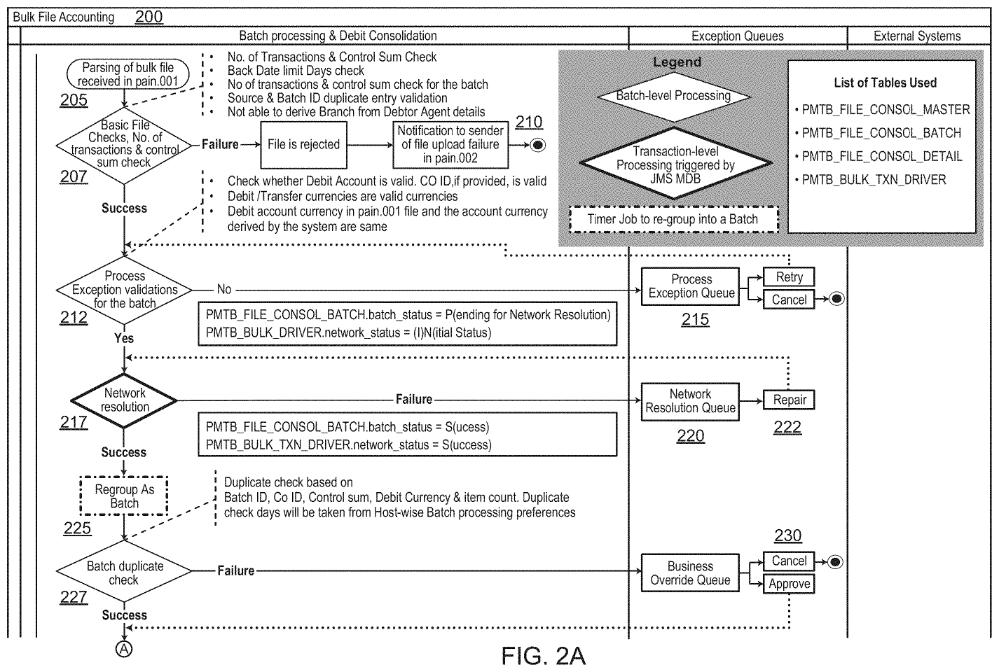

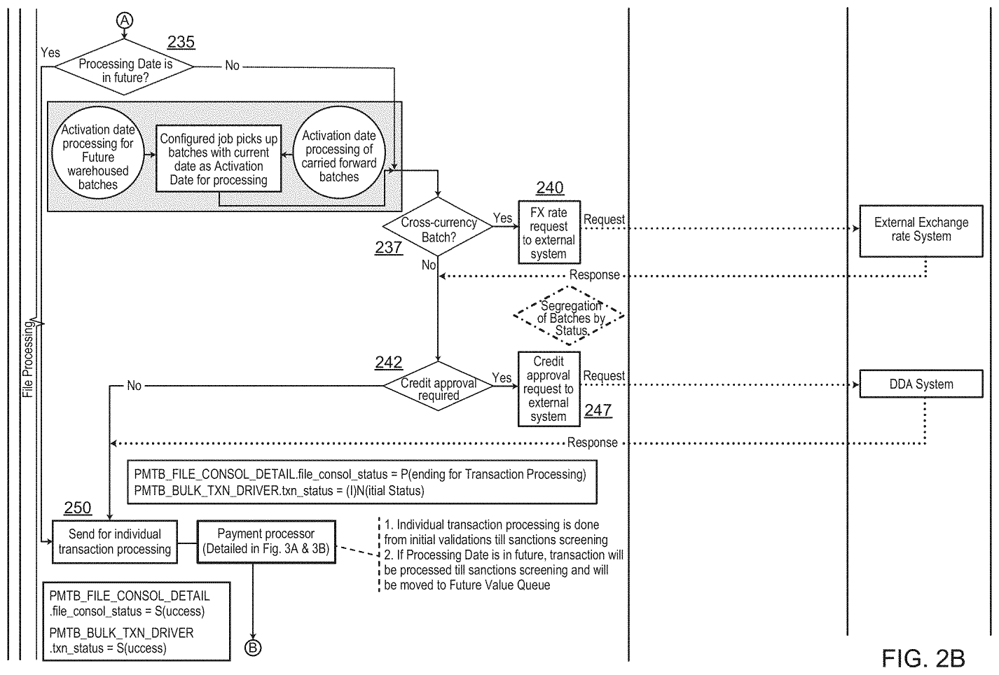

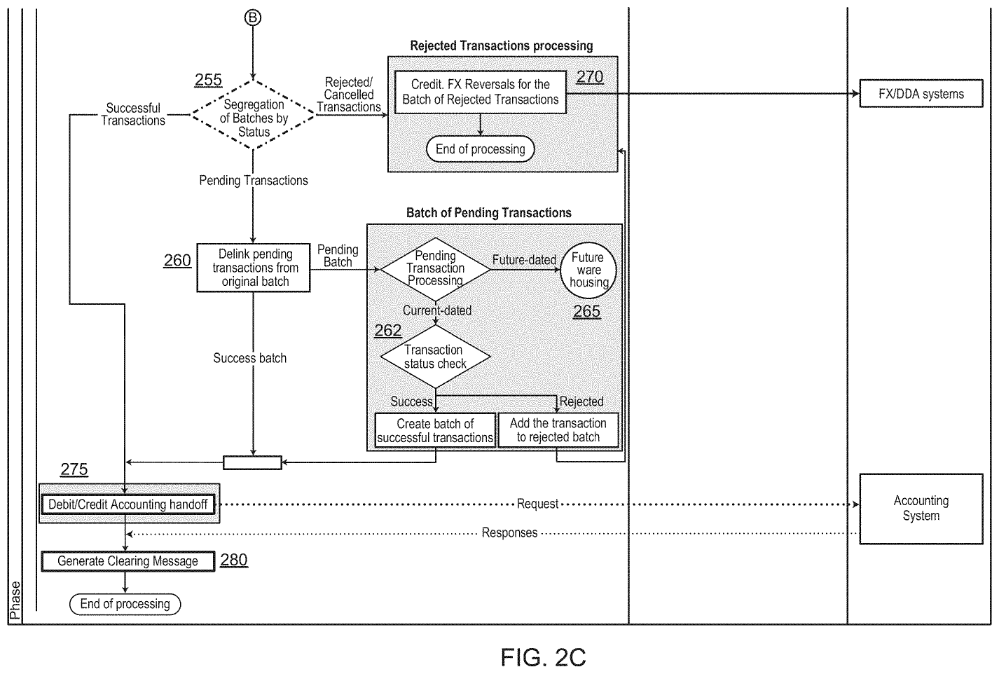

FIGS. 2A-2C, 3A-3B, and 4 illustrate techniques for handling bulk file processing more efficiently in payments using JMS queues while maintaining file level consistency according to various embodiments. Individual embodiments may be described as a process which is depicted as a flowchart, a flow diagram, a data flow diagram, a structure diagram, swim lane diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

The processes and/or operations depicted by in FIGS. 2A-2C, 3A-3B, and 4 may be implemented in software (e.g., code, instructions, program) executed by one or more processing units (e.g., processors cores), hardware, or combinations thereof. The software may be stored in a memory (e.g., on a memory device, on a non-transitory computer-readable storage medium). The particular series of processing steps in FIGS. 2A-2C, 3A-3B, and 4 is not intended to be limiting. Other sequences of steps may also be performed according to alternative embodiments. For example, in alternative embodiments the steps outlined above may be performed in a different order. Moreover, the individual steps illustrated in FIGS. 2A-2C, 3A-3B, and 4 may include multiple sub-steps that may be performed in various sequences as appropriate to the individual step. Furthermore, steps may be added or removed depending on the particular applications. One of ordinary skill in the art would recognize many variations, modifications, and alternatives

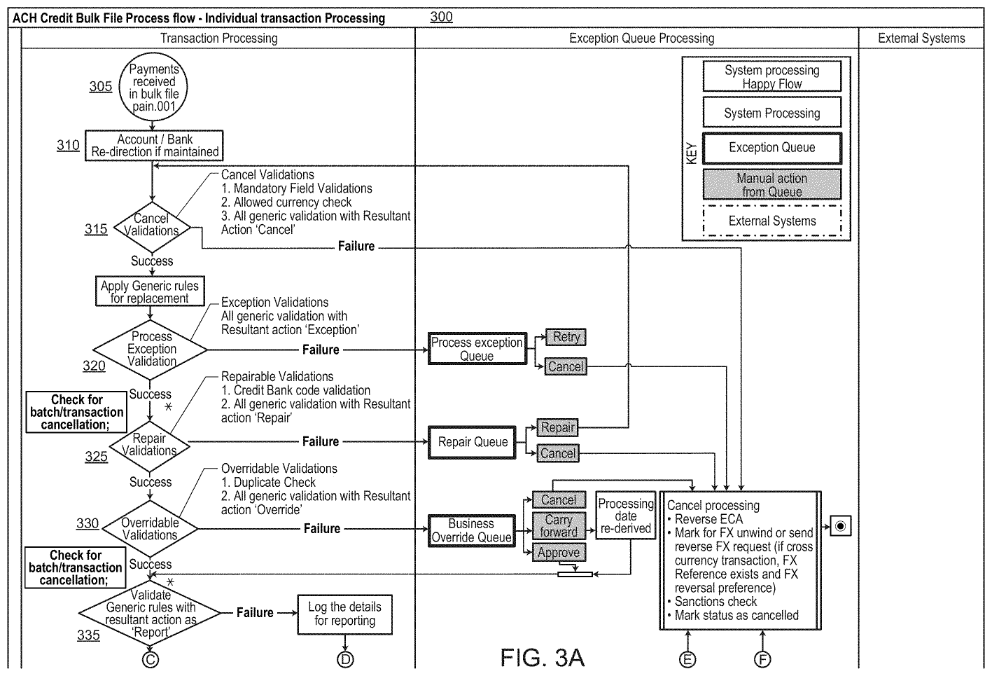

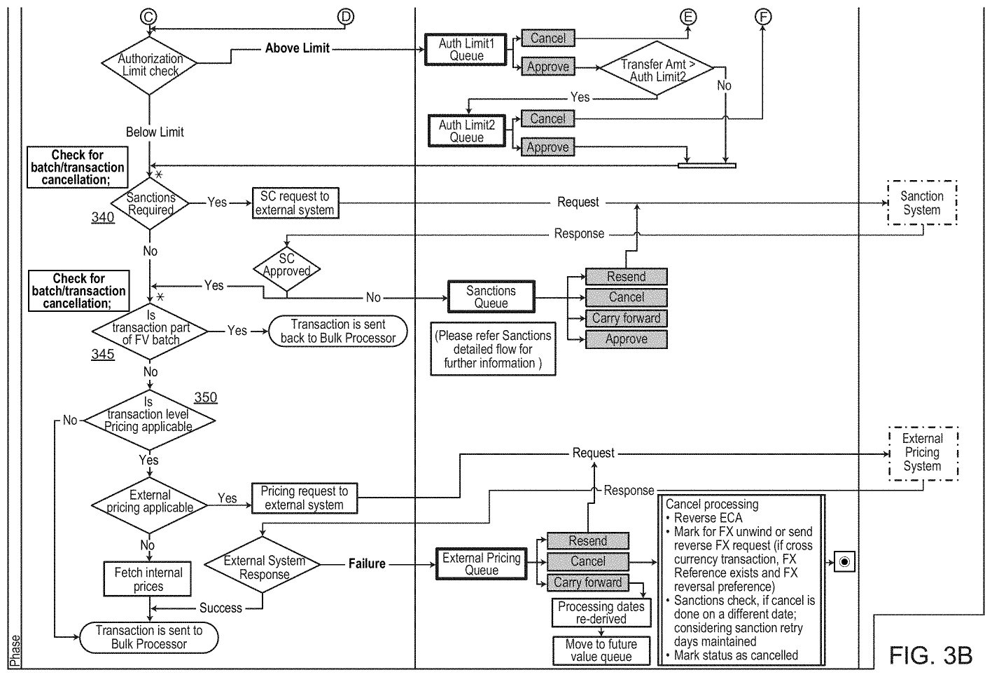

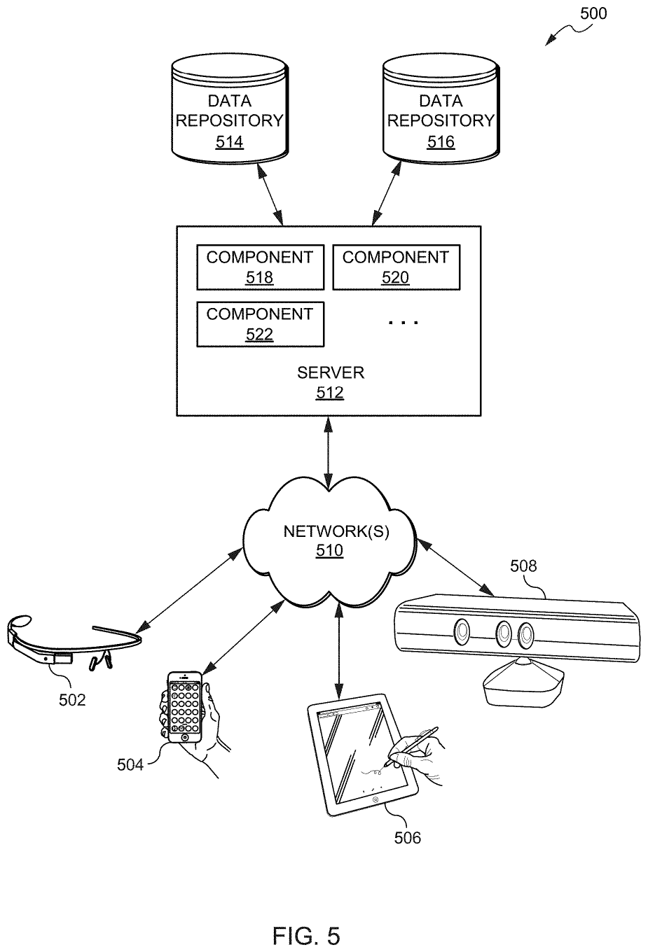

FIGS. 2A-2C depict a swim lane diagram 200 illustrating an example of bulk file accounting according to various embodiments. FIGS. 3A-3B depicts a swim lane diagram 300 illustrating an example of individual transaction processing according to various embodiments. The processing depicted in FIGS. 2A-2C and 3A-3B may be performed by a payment system as described with respect to FIG. 1 using one or more of the illustrative systems described with respect to FIGS. 5-7.

At block 205, a bulk file is received at a payment processing system (e.g., a data processing system) of a PSP and parsed/analyzed. The bulk file defines a schedule of transactions (e.g., payments or debits) to be made by electronic funds transfer (e.g., ACH or wire transfers), which moves money from one or more accounts to one or more other accounts electronically over a computerized network. The bulk file may be received using JMS messaging. The JMS is an API which supports the formal communication or messaging between computers on a network (e.g., between the front-end arrangements and back-end arrangements of the payment processing system). The bulk file is processed by consolidating the transactions into batches based on network, debit account, value date, transfer currency, charge account, or any combination thereof. The payment processing system may support processing of bulk files received from corporate customers containing mixed workloads (e.g., transactions from various networks, accounts, dates, etc.). In some instances, the payment processing system can upload and process files received from corporate customers containing bulk payment initiation requests in pain.001 format (a Customer Credit Transfer Initiation (pain.001) XML message, which is used for the electronic commissioning of payment orders by the customer to the payment submitting financial institution). The bulk payment initiation requests may be for any of the following payment types: Domestic Low Value Payment (ACH), Domestic High Value Payment (RTGS), Cross-border Payment, or Book Transfer. An initial master table (PMTB_FILE_CONSOL_MASTER) is used to house records for each batch in the bulk file, as identified by the Batch ID aka <PmtInfId> tag of pain.001.

Thereafter, the bulk files are parsed, validated and processed so that payments are forwarded to appropriate Networks (e.g., back-end arrangements 125 as described with respect to FIG. 1). The payment processing system can maintain customer preferences for bulk file processing. Batch IDs (e.g., the ID received in the tag PaymentInformationIdentification <PmtInfId> of pain.001) provided in the bulk file remain linked to each transaction till the end of the payment life cycle. Batch IDs are available as a transaction level information for view and query. The data processing system parses the bulk file, e.g., the bulk file received in pain.001 format and performs basic file checks such as file format checks, determines a number of transactions to be processed (both file and batch level transactions), and performs control sum checks. Control sum, which may be available in the Group header (file level) and PaymentInformation <PmtInf> (batch level), is considered for the check. Since these are optional fields, if the tag is not available for the file or batch, this check may be skipped.

At block 207, based on the results of the basic file checks and control sum checks, a determination is made as to whether the upload of the bulk file is successful. For example, all transactions in a batch file should satisfy a back date limit days check (the transaction is not past an expiration date), and if not, then the bulk file is rejected and the upload of the bulk file is unsuccessful. Additionally, the number of transactions and check sums may be checked per file level and batch level to ensure no errors were introduced during the batch file transmission or storage. For example, if the number of transactions fails to match the check sum for total transactions (file or bulk level), then the bulk file is rejected and the upload of the bulk file is unsuccessful. Moreover, if the payment processing system is unable to derive account details such as account numbers or branch details from the debtor agent details, then the bulk file is rejected and the upload of the bulk file is unsuccessful. Additionally, the batches of consolidated transactions may be checked for duplicity. This check may be performed based on the following parameters: (i) Batch IDCo ID—Co ID received in the payment request, e.g., CstmrCdtTrfInitn/PmtInf/Dbtr/Id/OrgId/Othr/Id/SchmeNm/Prtry, (ii) control sum (the control sum at batch ID level split by transfer currency, (iii) currency pair (the debit account currency and CurrencyOfTransfer <CcyOfTrf> will be considered; if account is provided as International Bank Account Number (IBAN), the payment processing system will find the corresponding account for fetching the debit account currency, and/or (iv) item count (item count available for Batch ID split by transfer currency). Duplicate days may be considered based on the information available in batch processing preferences. If there are batch duplicates, then the bulk file is rejected and the upload of the bulk file is unsuccessful.

At block 210, in response to the bulk file being rejected, a notification is sent to the sender of the bulk file letting them know that there has been a bulk file upload failure. The notification may be sent using a pain.002 message. The XML message Customer Payment Status Report (pain.002) is used by the financial institution to inform customers about the status of pain.001 credit transfer orders that have been submitted.

At block 212, in response to the bulk file being accepted, process exception validations are checked at the batch level for each batch of the bulk file. For example, all transactions in a batch should have the same transfer currency and/or a valid currency, and if not, then the exceptions batch is moved to a process exception queue. Additionally, customers and their accounts may be checked. For example, if a customer status is determined to be closed, frozen, or the whereabouts not know or deceased, then the exceptions batch is moved to a process exception queue. Moreover, if an account status is determined to be closed, blocked, or frozen, then the exceptions batch is moved to a process exception queue. Additionally, debit accounts may be checked for status such as dormant or no debit status, and if the debit account is dormant or has a no debit status, then the exceptions batch is moved to a process exception queue. In some instances, batch duplicate check and status check for overridable status will be performed as a single step and in case of exceptions, the exceptions batch is moved to a business override queue.

At block 215, each exceptions batch can be approved or cancelled from the process exception queue or business override queue. If approved, the process exception validations are again performed on the exceptions batch at block 212. Carry forward action for an exceptions batch will be restricted for batches from the process exception queue or business override queue. If not approved, the exceptions batch is rejected.

For each batch that passes the process exception validations at block 212, information concerning each batch is stored within a set of tables. The set of tables include a first table (PMTB_FILE_CONSOL_BATCH.batch status) storing information concerning the status of each batch pending network resolution and second table (PMTB_BULK_TXN_DRIVER. network status) storing information concerning the initial status of each batch. The tables cascade from the file level to the batch level to the individual transaction level using common keys that reflect the hierarchy. The tables are designed to prevent data proliferation and maintain data consistence as the payment processing switches to the individual transaction level in the next step. The first table (PMTB_FILE_CONSOL_BATCH) stores information at a batch-level within a file. The second table (PMTB_BULK_TXN_DRIVER) stores information of each transaction within a batch. Using the BATCH_STATUS column of the first table (PMTB_FILE_CONSOL_BATCH) allows to control the processing at the batch level. The NETWORK_STATUS column allows to track the network resolution step of each transaction. Only when all transactions within the batch have a resolved network resolution status, will the BATCH_STATUS column be updated to reflect the completion of the network resolution of all the transactions within that batch.

At block 217, network resolution is performed at the individual transaction level for each individual transaction (e.g., payment record) within a batch. JMS Queues are used for performing the network resolution at the individual transaction level. In the point-to-point messaging domain the payment processing application is built on the basis of message queues, senders and receivers. Each and every JMS message is addressed to a particular queue. Queues retain all messages sent to them until the messages are consumed or expired. The network resolution is implemented with a JMS-MDB designed for an individual transaction level network resolution process. The JMS-MDB will use the set of tables (the first table (PMTB_FILE_CONSOL_BATCH.batch status) and the second table (PMTB_BULK_TXN_DRIVER. network status)) for the processing. The network resolution process comprises retrieving the underlying numeric values corresponding to computer hostnames, account user names, group names, and other named entities based on rules defined in a network rule maintenance table. Payments are marked as urgent or non-urgent payments based on the linked payment type for each individual transaction. The network resolution of urgent payments is not processed as batches. Each individual transaction in the batch is processed as an individual transaction. However, the network resolution of non-urgent payments is processed as batches irrespective of the batch booking tag value in the incoming batch. If the network resolution fails for an individual transaction, the individual transaction is moved to network resolution queue at block 220. At block 222, from the network resolution queue, numeric values corresponding to computer hostnames, account user names, group names, and other named entities such as a network ID is provided for each individual transaction manually.

At block 225, a first timer job keeps track of processing completion of network resolution for each individual transaction. Timer Jobs are software programs that run in the back-ground to do only a particular job. Upon executing that job, the software program halts till it is triggered again after a certain fixed time-interval. The software platform provides for a timer function that goes off at every fixed time-interval, e.g., a second, 30 seconds, a minute, an hour, etc. Each time the timer function goes off, the software program is triggered. In present context, the timer jobs are used, for example, when the payment records in the batch are processed for network resolution at the individual transaction level. The network resolution for each payment record is processed using an MDB. The timer job's function is to check if each one of the payment record's network resolution step has been resolved. If resolved, the timer job has to trigger the next step in the process flow. If even a single payment record is pending to be processed for the network resolution, the timer job should not trigger the next step, instead halt the execution, only to be awakened again by the timer after the fixed time-interval.

Upon completion, the first timer jobs collates the individual transactions and triggers the next stage of batch level processing at block 227/235. The collating or regrouping of the individual transactions may be performed using the following parameters: network, Batch IDCo ID—Co ID, a currency exchange reference (if available as part of CreditTransferTransaction Information <CdtTrfTxInf>), or any combination thereof. A new consol reference (Batch IDCo ID—Co ID) is generated for each regrouped batch. Original Batch IDCo ID—Co ID is retained if there is only one batch after regrouping. Additionally, Java Persistence API control will update information concerning the network resolution for each individual transaction within the set of tables. For example, the BATCH_STATUS column of the first table (PMTB_FILE_CONSOL_BATCH) is updated only when the network resolution of every transaction is resolved. The first table is at the batch level, and so the first table does not carry the network resolution status of each individual transaction. In contrast, the NETWORK_STATUS of the second table (PMTB_BULK_TXN_DRIVER) is updated upon network resolution of each individual transaction. The status control columns in the set of tables are used to control the flow of collating the data from the previous transaction-level by the first timer job.

At block 227, the batches of consolidated transactions may again be checked for duplicity. This check may be performed based on the following parameters: (i) Batch IDCo ID—Co ID assigned to the batches, e.g., CstmrCdtTrfInitn/PmtInf/Dbtr/Id/OrgId/Othr/Id/SchmeNm/Prtry, (ii) control sum (the control sum at batch ID level split by transfer currency, (iii) currency pair (the debit account currency and CurrencyOfTransfer <CcyOfTrf> will be considered; if account is provided as International Bank Account Number (IBAN), the payment processing system will find the corresponding account for fetching the debit account currency, and/or (iv) item count (item count available for Batch ID split by transfer currency). Duplicate days may be considered based on the information available in batch processing preferences. In case of exceptions, the exceptions batch is moved to a business override queue.

At block 230, each exceptions batch can be approved or cancelled from the business override queue. If approved, the exceptions batch is forwarded to the next stage of batch level processing at block 235. If not approved, the exceptions batch is rejected.

At block 235, a determination is made as to whether the requested execution date (processing date) for each batch is in the future. The requested execution date for all transactions within a batch is same and this date is considered as the instruction date. An activation date is derived based on the instruction date. Debit currency/Credit currency/Network holiday checks is applied to instruction date as applicable for the payment type. A branch holiday check is performed on the activation date if the same is applicable for the Network. After deriving the dates, if the activation date falls on the current date, a process cut off check is performed for the batch based on the cutoff time maintained in customer preferences. If cutoff time is over, the request date is moved forward automatically if ‘Move Forward after Cutoff Time’ flag is checked in customer preferences. Otherwise, the batch moves to process cutoff queue (not shown). A release, cancel options is available for the batch from the process cutoff queue. If the determination is made that the requested execution date for a batch is not in the future, then the batch is sent for an exchange rate processing at block 237. However, if the determination is made that the requested execution date for a batch is in the future, then the batch is sent to the payment processor for individual processing at block 250.

At block 237, a determination is made as to whether a cross currency transaction is required to be performed for each batch (e.g., will a batch have a transaction that involves converting the payment between two or more currencies such as from Rupee to US dollar). If the determination is made that a batch has a cross currency transaction, then the batch is sent for retrieving an exchange rate at block 240. If the determination is made that a batch does not have a cross currency transaction, then the batch is sent for balance check processing at block 242.

At block 240, exchange rates are fetched for the cross currency transaction of the batch. Internal rates may be fetched for the batch if the batch amount is below the currency exchange rate limit maintained in customer preferences. If batch transfer currency is different from the limit currency maintained, the batch amount may be converted to limit currency amount using the midrate between the currencies. If the batch amount is more than limit amount, the batch details may be sent for an external rate fetch from an external exchange rate system at block 245 (optionally the batch details are only sent if the external rate fetch is applicable for the customer). If a currency exchange reference number is available as part of the payment request, the currency exchange reference number may be sent to external exchange rate system for reference.

At block 242, after any applicable the currency exchange conversion, the total batch amount is computed which includes the batch charges, if any. A determination is made as to whether a credit approval is required to be performed for each batch. The determination of credit approval may be made based on the calculated total batch amount and/or preferences of the PSP. If the determination is made that a batch does require a credit approval, then the batch is sent for credit approval processing at block 247. If the determination is made that a batch does require a credit approval, then the batch is sent to the payment processor for individual processing at block 250.

At block 247, the total amount calculated in block 242 along with other payment details is sent to an external system (e.g., a DDA system) for Customer/account validation, balance check and amount block in debit account. If the amount block is a success, the reference received, called the external credit approval (ECA) block reference, is stored for the batch and the individual payments in the batch are sent to the payment processor for further processing at block 250. If a batch is released from credit approval queue on a later date, rollover preference for queues is applied based on outbound non-urgent payment preferences maintained for the source, Batch IDCo ID—Co ID assigned to the batches, and debit account. Rollover preference may be auto roll, cancel or retain in queue. If cancellation is done, a currency exchange unwind request is sent.

For each batch sent to the payment processor for individual processing at block 250, information concerning each batch is stored within a set of tables. The set of tables include a third table (PMTB_FILE_CONSOL_DETAIL.file consol status) storing information concerning the status of each batch pending individual transaction payment processing and the second table (PMTB_BULK_TXN_DRIVER.txn.status) storing information concerning the initial status of each batch. The second table (PMTB_BULK_TXN_DRIVER), as explained in detailer herein, stores information for each transaction within a batch. The column TXN_STATUS tracks the Transaction processing as described in Block 250 of the FIG. 2B. The third table (PMTB_FILE_CONSOL_DETAIL) stores data of each consolidated batch (after the regrouping step at block 225 of FIG. 2A). The column FILE_CONSOL_STATUS tracks the status of the consolidated batch. Until each individual transaction under the consolidated batch is marked processed, as described in the TXN_STATUS column of the PMTB_BULK_TXN_DRIVER table, the FILE_CONSOL_STATUS column of PMTB_FILE_CONSOL_DETAIL will not be updated. It is only when every transaction record is processed at that level, will the FILE_CONSOL_STATUS column at a hierarchy above be marked processed.

At block 250, payment processing is performed at the individual transaction level for each individual transaction within a batch. JMS Queues are used for performing the payment processing at the individual transaction level. Payment processing is implemented with a JMS-MDB designed for an individual transaction level payment processing process. The JMS-MDB will use the set of tables (third table (PMTB_FILE_CONSOL_DETAIL.file consol status) and the second table (PMTB_BULK_TXN_DRIVER.txn.status) for the payment processing.

The payment processing for individual transactions is discussed in detail with reference to FIGS. 3A-3B. The payment processing for individual transactions is performed from initial validations at block 310 till pricing at block 350. If the processing date is in the future, the individual transaction will be processed till sanctions screening at block 340 and then moved to a future value queue till the processing date (see, e.g., block 345). At block 305, the bulk file is received by the payment processor for individual processing. In some instances, the payment processor for individual processing can upload and process files received in pain.001 format (a Customer Credit Transfer Initiation (pain.001) XML message. At blocks 310-335, individual payment validations for cancelation (315), process exception (320), repair (325), business override (330), and authorization limit (335) are performed. Since the status validations for customer/debit account are already performed at batch level, this process is not be repeated again while processing individual transactions for current dated batches. For book transfers, the credit account status validations may be performed. At block 340, a sanction check is performed and it is possible to process sanction seizure. The processing of a seized transaction is at individual transaction level. Accounting is posted debiting the customer account and crediting the seizure, if applicable. At block 350, if a charge account is provided in the payment request the same is used for debiting the charges. If not available in the request the charge account maintained in customer preferences is used as debit amount for charges. If no preference is available transaction debit account is used as the charge account as well. In some instances, no amount block is performed for charge accounting. Charges may be force posted. Upon completion of the payment processing for each individual transaction, the status of each individual transaction is updated. For example the status may be updated as one of the following: success (all processing steps 305-350 are completed), canceled (payment is canceled from an exceptions queue), seized (sanction seizure applied to the payment), or pending (payment is pending in an exceptions queue).

With respect back to FIG. 2C, at block 255, a second timer job keeps track of processing completion of payment processing for each individual transaction. Upon completion of process 300 for each of the individual transactions, the second timer jobs collates the individual transactions into batches and triggers the next stage of batch level processing at block 260/270/275. The collating or regrouping of the individual transactions is performed using the payment processing status. Additionally, Java Persistence API control will update information concerning the payment processing for each individual transaction within the set of tables. For example, the third table (PMTB_FILE_CONSOL_DETAIL.file consol status) is updated with the payment process status of each individual transaction of each batch and the second table (PMTB_BULK_TXN_DRIVER.txn_status) is updated with the overall status of each individual transaction for each batch. The status control columns in the set of tables are used to control the flow of collating the data from the previous transaction-level by the second timer job.

At block 260, pending transactions are delinked from the original batch allowing for successful transactions to be processed. In some instances, a batch is closed and Network cutoff check/accounting are performed if: (i) all transactions are processed successfully, or (ii) processing preferences is completed ahead of Host network cutoff or completion of the wait time configured for batch processing. For example, a file is received at 10 a.m. and another file at 2.30 p.m. with a wait time maintained being 2 hours and Host network cutoff being @3.45. If all transactions are not processed successfully for the first file, @ 12 p.m, the payment system segregates the successful transactions from the parent batch and creates a child batch. This child batch of successful transactions is processed further. The pending transactions remains in the original batch. For the second batch wait time ends at 4.30 p.m. Since the Host network cutoff is earlier to this, the segregation of successful transactions to a child batch happens at 3.45. Accordingly, whenever successful transactions are sent for processing generating a child batch, the pending transactions will remain in the original batch. The pending batch will be checked again at block 262 for successful transactions at regular intervals. This will be achieved by configuring a job which can be run at pre-defined intervals. In certain instances, the time interval is set in minutes. The check for successful transactions will continue till the Host network cutoff time is reached. If pending transactions are remaining in the batch even after reaching the Host network cutoff time, the batch is carried forwarded to next business day or the pending transactions are added to a rejected batch.

At block 265, processing of future dated or carried forward batches occurs as follows: on the value date, based on booking date processing, a separate batch is created for successful transactions. This batch is considered for value date processing. A currency exchange and amount block are performed and transactions are sent for individual payment processing. The rest of the process flow remains same as described in detail with respect to a current dated batch processed in FIGS. 3A-3B. The new job runs in regular intervals rechecking the transaction status of the transactions in the pending batches. In certain instances, the monitoring interval is configured in minutes in payments auto job parameters,

At block 270, a currency exchange rewind request and amount block reversal request are sent for each rejected or cancelled transaction. Each rejected or canceled transaction for current date within a consolidation batch may be part of the same reject or canceled batch. Not shown here, but if any transaction is moved to seized status from sanction queue during individual processing, a separate seized batch is created. Every seized transaction for current date within a consolidation batch is part of the same seized batch. The processing of a seized transaction is at the individual transaction level. Accounting is posted debiting the customer account and crediting the seizure, if applicable.

At block 275, if all transactions have a success status, the Host network cutoff may be checked for the batch based on the time maintained in network rule maintenance table. If Host network cutoff is over, the payment is moved to network cutoff queue. Force release, cancel and carry forward actions are possible from the network cutoff queue. If a batch is canceled from the network cutoff queue, the unwind requests for currency exchange and account block are sent. The debit accounting is applicable for successfully completed transactions at the individual transaction level. JMS Queues are used for performing the debit accounting at the individual transaction level. Debit accounting is implemented with a JMS-MDB designed for an individual transaction level payment processing process. The JMS-MDB will use the set of tables (third table (PMTB_FILE_CONSOL_DETAIL.file consol status) and the second table (PMTB_BULK_TXN_DRIVER.txn.status) for the debit accounting. In some instances, the debit accounting is only applicable if: (i) batch booking tag value in the incoming file for the Batch ID is ‘Yes’, and (ii) batch booking tag is not available for the Batch ID, in the Non-urgent payment preferences, ‘Batch debit accounting’ field value set as ‘Consolidated’. Individual debit entries may be posted if batch booking tag in the file for the Batch ID is set as ‘No’ or if the tag is not available for the Batch ID, then in the Non-urgent payment preferences, ‘Batch debit accounting’ field value set as ‘Itemized’. Credit amount may be passed for accounting as consolidated batch amount irrespective of the debit accounting preference.

At block 280, the user or customer is informed about the status of the payments by generating messages (e.g., pain.002 messages). In some instances, if the file is rejected due to format issues, pain.002 is generated for the file. OriginalGroupInformationAndStatus <OrgnlGrpinfAndSts> tag is updated with the status rejected. Since the entire file is rejected, individual payment information will not be populated. In all other instances, the generation of the message is original Batch ID-wise. The messages are generated if all the transactions in a batch are marked with final status, success, rejected, canceled or seized. If any transaction in a batch is remaining pending, then the message may be generated during end of day based on a new job.

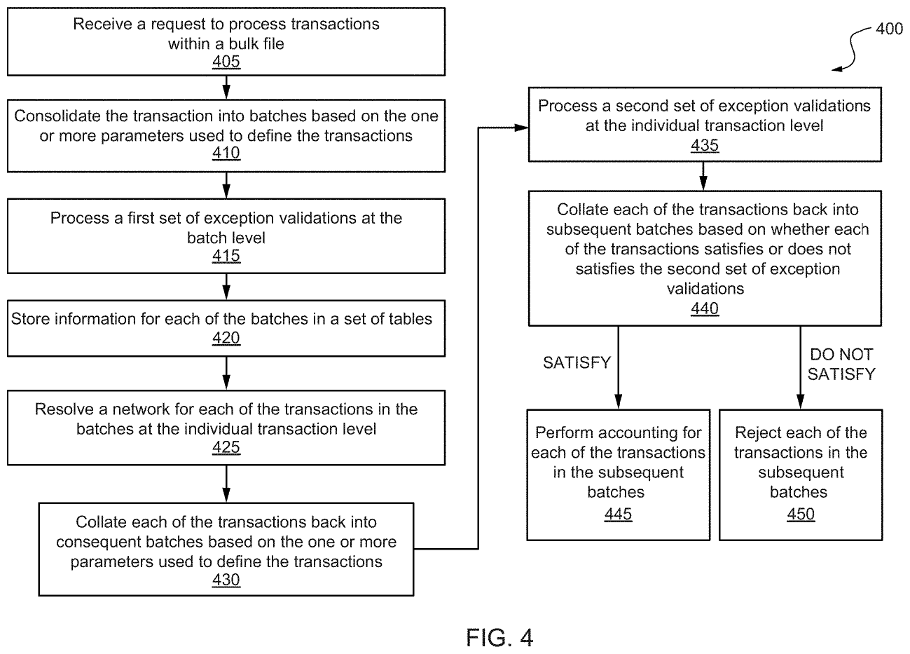

FIG. 4 depicts a flow diagram 400 illustrating an example of processing for handling bulk file processing more efficiently in payments using JMS queues while maintaining file level consistency according to certain embodiments. The processing depicted in FIG. 4 may be performed by a payment system as described with respect to FIG. 1 using one or more of the illustrative systems described with respect to FIGS. 5-7.

At block 405, a request is received by a data processing system to process transactions within a bulk file.

At block 410, the transactions are consolidated into batches based on one or more parameters used to define the transactions. As used herein, when an action is “based on” something, this means the action is based at least in part on at least a part of the something. The one or more parameters may be network, debit account, value date, transfer currency, charge account, or any combination thereof.

At block 415, a first set of exception validations is processed by the data processing system (at a batch level) for each of the batches to identify batches that satisfy or do not satisfy the first set of exception validations. The first set of exception validations may be performed in accordance with the description of blocks 207-215 described with respect to FIG. 2A.

At block 420, information for each of the batches that satisfies the first set of exception validations is stored by the data processing system within a set of tables. The tables cascade from a file level to a batch level to an individual transaction level using common keys that reflect a hierarchy. The set of tables may comprise a first table and a second table. The first table provides a batch status for each of the batches and the second table provides a network status and validation status for each of the transactions.

At block 425, a network associated with each of the transactions is resolved by the data processing system (at the individual transaction level). The JMS Queues implementing: (i) a MDB specifically configured for the resolution of the network, and (ii) the set of tables (e.g., the first table and the second table), are used for the resolving the network at the individual transaction level. The network may be resolved in accordance with the description of blocks 217-222 described with respect to FIG. 2A.

At block 430, each of the transactions is collated by the data processing system into consequent batches based on the one or more parameters used to define the transactions. A timer job implementing the set of tables is used to collate each of the transactions into the consequent batches. Additionally, information for each of the consequent batches may be stored by the data processing system within the set of tables. The set of tables may thus further comprise a third table that provides a batch status for each of the consequent batches.

At block 435, a second set of exception validations is process by the data processing system (at an individual transaction level) for each of the transactions within the consequent batches that satisfy the first set of exception validations in order to identify transactions that satisfy or do not satisfy the second set of exception validations. The JMS Queues implementing: (i) a MDB specifically configured for the processing of the second set of exception validations, and (ii) the set of tables (e.g., the third table and the second table), are used for the processing of the second set of exception validations at the individual transaction level. The second set of exception validations may be performed in accordance with the description of blocks 310-335 described with respect to FIG. 3A.

At block 440, each of the transactions are collated into subsequent based on whether each of the transactions satisfies or does not satisfies the second set of exception validations. A timer job implementing the set of tables is used to collate each of the transactions into the subsequent batches.

At block 445, each of the transactions in the subsequent batches that satisfy the second set of exception validations are processed by the data processing system (at the individual transaction level). In some instances, the processing comprises performing an accounting of each of the transactions in the subsequent batches that satisfy the second set of exception validations. The accounting comprises issuing a payment and debiting an associated account for each of the transactions. The accounting may be performed in accordance with the description of blocks 275-280 described with respect to FIG. 2C.

At block 450, each of the transactions in the subsequent batches that do not satisfy the second set of exception validations are rejected by the data processing system at the individual transaction level. The rejecting may be performed in accordance with the description of block 270 described with respect to FIG. 2C.

### Illustrative Systems

FIG. 5 depicts a simplified diagram of a distributed system 500 for implementing an embodiment. In the illustrated embodiment, distributed system 500 includes one or more client computing devices 502, 504, 506, and 508, coupled to a server 512 via one or more communication networks 510. Clients computing devices 502, 504, 506, and 508 may be configured to execute one or more applications.

In various embodiments, server 512 may be adapted to run one or more services or software applications that enable processing bulk files that have a unique processing requirement to handle both a batch-level and a transaction-level processing alternating with each other during the course of the bulk file processing.

In certain embodiments, server 512 may also provide other services or software applications that can include non-virtual and virtual environments. In some embodiments, these services may be offered as web-based or cloud services, such as under a Software as a Service (SaaS) model to the users of client computing devices 502, 504, 506, and/or 508. Users operating client computing devices 502, 504, 506, and/or 508 may in turn utilize one or more client applications to interact with server 512 to utilize the services provided by these components.

In the configuration depicted in FIG. 5, server 512 may include one or more components 518, 520 and 522 that implement the functions performed by server 512. These components may include software components that may be executed by one or more processors, hardware components, or combinations thereof. It should be appreciated that various different system configurations are possible, which may be different from distributed system 500. The embodiment shown in FIG. 5 is thus one example of a distributed system for implementing an embodiment system and is not intended to be limiting.

Users may use client computing devices 502, 504, 506, and/or 508 to handle bulk file processing in accordance with the teachings of this disclosure. A client device may provide an interface that enables a user of the client device to interact with the client device. The client device may also output information to the user via this interface. Although FIG. 5 depicts only four client computing devices, any number of client computing devices may be supported.

The client devices may include various types of computing systems such as portable handheld devices, general purpose computers such as personal computers and laptops, workstation computers, wearable devices, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux or Linux-like operating systems such as Google Chrome™ OS) including various mobile operating systems (e.g., Microsoft Windows Mobile®, iOS®, Windows Phone®, Android™, BlackBerry®, Palm OS®). Portable handheld devices may include cellular phones, smartphones, (e.g., an iPhone®), tablets (e.g., iPad®), personal digital assistants (PDAs), and the like. Wearable devices may include Google Glass® head mounted display, and other devices. Gaming systems may include various handheld gaming devices, Internet-enabled gaming devices (e.g., a Microsoft Xbox® gaming console with or without a Kinect® gesture input device, Sony PlayStation® system, various gaming systems provided by Nintendo®, and others), and the like. The client devices may be capable of executing various different applications such as various Internet-related apps, communication applications (e.g., E-mail applications, short message service (SMS) applications) and may use various communication protocols.

Network(s) 510 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 510 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 512 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Server 512 can include one or more virtual machines running virtual operating systems, or other computing architectures involving virtualization such as one or more flexible pools of logical storage devices that can be virtualized to maintain virtual storage devices for the server. In various embodiments, server 512 may be adapted to run one or more services or software applications that provide the functionality described in the foregoing disclosure.

The computing systems in server 512 may run one or more operating systems including any of those discussed above, as well as any commercially available server operating system. Server 512 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, Sybase®, IBM® (International Business Machines), and the like.

In some implementations, server 512 may include one or more applications to analyze and consolidate data feeds and/or event updates received from users of client computing devices 502, 504, 506, and 508. As an example, data feeds and/or event updates may include, but are not limited to, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 512 may also include one or more applications to display the data feeds and/or real-time events via one or more display devices of client computing devices 502, 504, 506, and 508.

Distributed system 500 may also include one or more data repositories 514, 516. These data repositories may be used to store data and other information in certain embodiments. For example, one or more of the data repositories 514, 516 may be used to store information for handling bulk file processing. Data repositories 514, 516 may reside in a variety of locations. For example, a data repository used by server 512 may be local to server 512 or may be remote from server 512 and in communication with server 512 via a network-based or dedicated connection. Data repositories 514, 516 may be of different types. In certain embodiments, a data repository used by server 512 may be a database, for example, a relational database, such as databases provided by Oracle Corporation® and other vendors. One or more of these databases may be adapted to enable storage, update, and retrieval of data to and from the database in response to SQL-formatted commands.

In certain embodiments, one or more of data repositories 514, 516 may also be used by applications to store application data. The data repositories used by applications may be of different types such as, for example, a key-value store repository, an object store repository, or a general storage repository supported by a file system.

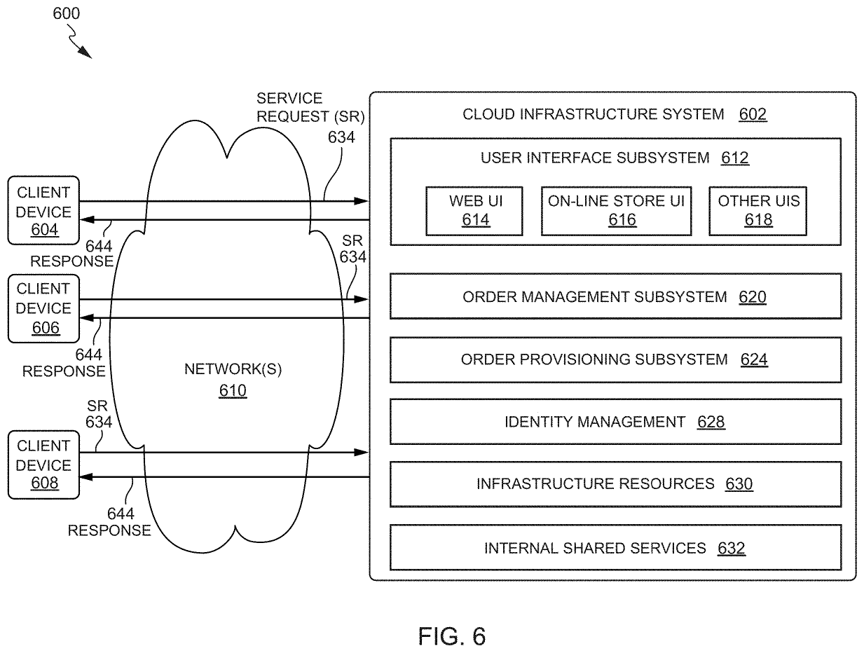

In certain embodiments, bulk file processing functionalities described in this disclosure may be offered as services via a cloud environment. FIG. 6 is a simplified block diagram of a cloud-based system environment in which the bulk file processing may be offered as cloud services, in accordance with certain embodiments. In the embodiment depicted in FIG. 6, cloud infrastructure system 602 may provide one or more cloud services that may be requested by users using one or more client computing devices 604, 606, and 608. Cloud infrastructure system 602 may comprise one or more computers and/or servers that may include those described above for server 512. The computers in cloud infrastructure system 602 may be organized as general purpose computers, specialized server computers, server farms, server clusters, or any other appropriate arrangement and/or combination.

Network(s) 610 may facilitate communication and exchange of data between clients 604, 606, and 608 and cloud infrastructure system 602. Network(s) 610 may include one or more networks. The networks may be of the same or different types. Network(s) 610 may support one or more communication protocols, including wired and/or wireless protocols, for facilitating the communications.

The embodiment depicted in FIG. 6 is only one example of a cloud infrastructure system and is not intended to be limiting. It should be appreciated that, in some other embodiments, cloud infrastructure system 602 may have more or fewer components than those depicted in FIG. 6, may combine two or more components, or may have a different configuration or arrangement of components. For example, although FIG. 6 depicts three client computing devices, any number of client computing devices may be supported in alternative embodiments.

The term cloud service is generally used to refer to a service that is made available to users on demand and via a communication network such as the Internet by systems (e.g., cloud infrastructure system 602) of a service provider. Typically, in a public cloud environment, servers and systems that make up the cloud service provider's system are different from the customer's own on-premise servers and systems. The cloud service provider's systems are managed by the cloud service provider. Customers can thus avail themselves of cloud services provided by a cloud service provider without having to purchase separate licenses, support, or hardware and software resources for the services. For example, a cloud service provider's system may host an application, and a user may, via the Internet, on demand, order and use the application without the user having to buy infrastructure resources for executing the application. Cloud services are designed to provide easy, scalable access to applications, resources and services. Several providers offer cloud services. For example, several cloud services are offered by Oracle Corporation® of Redwood Shores, Calif., such as middleware services, database services, Java cloud services, and others.

In certain embodiments, cloud infrastructure system 602 may provide one or more cloud services using different models such as under a Software as a Service (SaaS) model, a Platform as a Service (PaaS) model, an Infrastructure as a Service (IaaS) model, and others, including hybrid service models. Cloud infrastructure system 602 may include a suite of applications, middleware, databases, and other resources that enable provision of the various cloud services.

A SaaS model enables an application or software to be delivered to a customer over a communication network like the Internet, as a service, without the customer having to buy the hardware or software for the underlying application. For example, a SaaS model may be used to provide customers access to on-demand applications that are hosted by cloud infrastructure system 602. Examples of SaaS services provided by Oracle Corporation® include, without limitation, various services for human resources/capital management, customer relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware and networking resources) to a customer as a cloud service to provide elastic compute and storage capabilities. Various IaaS services are provided by Oracle Corporation®.

A PaaS model is generally used to provide, as a service, platform and environment resources that enable customers to develop, run, and manage applications and services without the customer having to procure, build, or maintain such resources. Examples of PaaS services provided by Oracle Corporation® include, without limitation, Oracle Java Cloud Service (JCS), Oracle Database Cloud Service (DBCS), data management cloud service, various application development solutions services, and others.

Cloud services are generally provided on an on-demand self-service basis, subscription-based, elastically scalable, reliable, highly available, and secure manner. For example, a customer, via a subscription order, may order one or more services provided by cloud infrastructure system 602. Cloud infrastructure system 602 then performs processing to provide the services requested in the customer's subscription order. For example, bulk file processing. Cloud infrastructure system 602 may be configured to provide one or even multiple cloud services.

Cloud infrastructure system 602 may provide the cloud services via different deployment models. In a public cloud model, cloud infrastructure system 602 may be owned by a third party cloud services provider and the cloud services are offered to any general public customer, where the customer can be an individual or an enterprise. In certain other embodiments, under a private cloud model, cloud infrastructure system 602 may be operated within an organization (e.g., within an enterprise organization) and services provided to customers that are within the organization. For example, the customers may be various departments of an enterprise such as the Human Resources department, the Payroll department, etc. or even individuals within the enterprise. In certain other embodiments, under a community cloud model, the cloud infrastructure system 602 and the services provided may be shared by several organizations in a related community. Various other models such as hybrids of the above mentioned models may also be used.

Client computing devices 604, 606, and 608 may be of different types (such as devices 502, 504, 506, and 508 depicted in FIG. 5) and may be capable of operating one or more client applications. A user may use a client device to interact with cloud infrastructure system 602, such as to request a service provided by cloud infrastructure system 602. For example, a user may use a client device to request bulk file processing service described in this disclosure.

In some embodiments, the processing performed by cloud infrastructure system 602 for providing business intelligent services may involve big data analysis. This analysis may involve using, analyzing, and manipulating large datasets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 602 for bulk file processing. The data used for this analysis may include structured data (e.g., data stored in a database or structured according to a structured model) and/or unstructured data (e.g., data blobs (binary large objects)).

As depicted in the embodiment in FIG. 6, cloud infrastructure system 602 may include infrastructure resources 630 that are utilized for facilitating the provision of various cloud services offered by cloud infrastructure system 602. Infrastructure resources 630 may include, for example, processing resources, storage or memory resources, networking resources, and the like.

In certain embodiments, to facilitate efficient provisioning of these resources for supporting the various cloud services provided by cloud infrastructure system 602 for different customers, the resources may be bundled into sets of resources or resource modules (also referred to as “pods”). Each resource module or pod may comprise a pre-integrated and optimized combination of resources of one or more types. In certain embodiments, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 602 may itself internally use services 632 that are shared by different components of cloud infrastructure system 602 and which facilitate the provisioning of services by cloud infrastructure system 602. These internal shared services may include, without limitation, a security and identity service, an integration service, an enterprise repository service, an enterprise manager service, a virus scanning and white list service, a high availability, backup and recovery service, service for enabling cloud support, an email service, a notification service, a file transfer service, and the like.

Cloud infrastructure system 602 may comprise multiple subsystems. These subsystems may be implemented in software, or hardware, or combinations thereof. As depicted in FIG. 6, the subsystems may include a user interface subsystem 612 that enables users or customers of cloud infrastructure system 602 to interact with cloud infrastructure system 602. User interface subsystem 612 may include various different interfaces such as a web interface 614, an online store interface 616 where cloud services provided by cloud infrastructure system 602 are advertised and are purchasable by a consumer, and other interfaces 618. For example, a customer may, using a client device, request (service request 634) one or more services provided by cloud infrastructure system 602 using one or more of interfaces 614, 616, and 618. For example, a customer may access the online store, browse cloud services offered by cloud infrastructure system 602, and place a subscription order for one or more services offered by cloud infrastructure system 602 that the customer wishes to subscribe to. The service request may include information identifying the customer and one or more services that the customer desires to subscribe to. For example, a customer may place a subscription order for a business intelligent related service offered by cloud infrastructure system 602. As part of the order, the customer may provide information identifying complex and time-sensitive business scenarios to be solved.

In certain embodiments, such as the embodiment depicted in FIG. 6, cloud infrastructure system 602 may comprise an order management subsystem (OMS) 620 that is configured to process the new order. As part of this processing, OMS 620 may be configured to: create an account for the customer, if not done already; receive billing and/or accounting information from the customer that is to be used for billing the customer for providing the requested service to the customer; verify the customer information; upon verification, book the order for the customer; and orchestrate various workflows to prepare the order for provisioning.

Once properly validated, OMS 620 may then invoke the order provisioning subsystem (OPS) 624 that is configured to provision resources for the order including processing, memory, and networking resources. The provisioning may include allocating resources for the order and configuring the resources to facilitate the service requested by the customer order. The manner in which resources are provisioned for an order and the type of the provisioned resources may depend upon the type of cloud service that has been ordered by the customer. For example, according to one workflow, OPS 624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting customer for providing the requested service.

Cloud infrastructure system 602 may send a response or notification 644 to the requesting customer to indicate when the requested service is now ready for use. In some instances, information (e.g., a link) may be sent to the customer that enables the customer to start using and availing the benefits of the requested services. In certain embodiments, for a customer requesting business intelligence service, the response may include a request for complex and time-sensitive business scenarios to be solved.

Cloud infrastructure system 602 may provide services to multiple customers. For each customer, cloud infrastructure system 602 is responsible for managing information related to one or more subscription orders received from the customer, maintaining customer data related to the orders, and providing the requested services to the customer. Cloud infrastructure system 602 may also collect usage statistics regarding a customer's use of subscribed services. For example, statistics may be collected for the amount of storage used, the amount of data transferred, the number of users, and the amount of system up time and system down time, and the like. This usage information may be used to bill the customer. Billing may be done, for example, on a monthly cycle.

Cloud infrastructure system 602 may provide services to multiple customers in parallel. Cloud infrastructure system 602 may store information for these customers, including possibly proprietary information. In certain embodiments, cloud infrastructure system 602 comprises an identity management subsystem (IMS) 628 that is configured to manage customers information and provide the separation of the managed information such that information related to one customer is not accessible by another customer. IMS 628 may be configured to provide various security-related services such as identity services, such as information access management, authentication and authorization services, services for managing customer identities and roles and related capabilities, and the like.

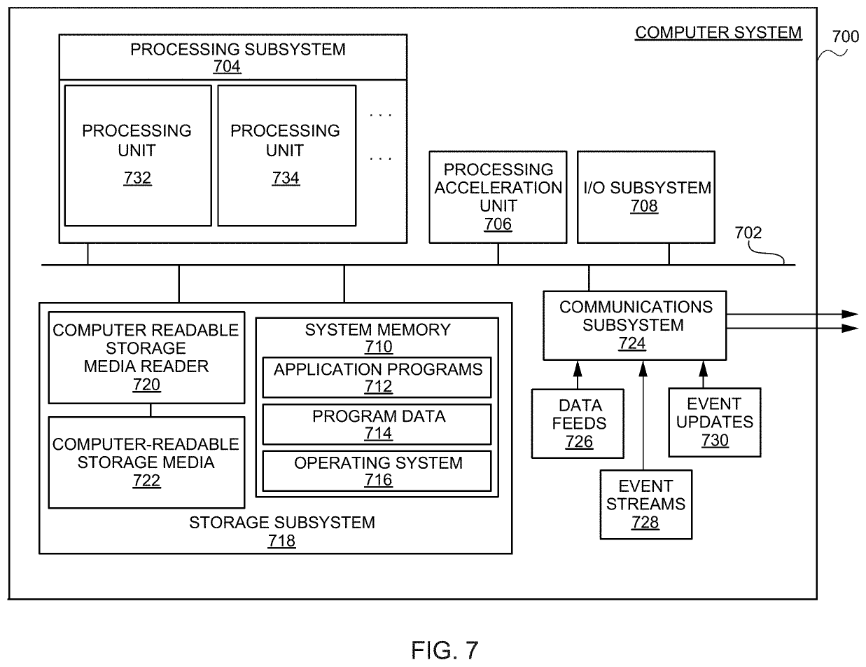

FIG. 7 illustrates an exemplary computer system 700 that may be used to implement certain embodiments. For example, in some embodiments, computer system 700 may be used to implement any of the bulk file processing systems, payment processing systems, and/or various servers and computer systems described above. As shown in FIG. 7, computer system 700 includes various subsystems including a processing subsystem 704 that communicates with a number of other subsystems via a bus subsystem 702. These other subsystems may include a processing acceleration unit 706, an I/O subsystem 708, a storage subsystem 718, and a communications subsystem 724. Storage subsystem 718 may include non-transitory computer-readable storage media including storage media 722 and a system memory 710.

Bus subsystem 702 provides a mechanism for letting the various components and subsystems of computer system 700 communicate with each other as intended. Although bus subsystem 702 is shown schematically as a single bus, alternative embodiments of the bus subsystem may utilize multiple buses. Bus subsystem 702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 704 controls the operation of computer system 700 and may comprise one or more processors, application specific integrated circuits (ASICs), or field programmable gate arrays (FPGAs). The processors may include be single core or multicore processors. The processing resources of computer system 700 can be organized into one or more processing units 732, 734, etc. A processing unit may include one or more processors, one or more cores from the same or different processors, a combination of cores and processors, or other combinations of cores and processors. In some embodiments, processing subsystem 704 can include one or more special purpose co-processors such as graphics processors, digital signal processors (DSPs), or the like. In some embodiments, some or all of the processing units of processing subsystem 704 can be implemented using customized circuits, such as application specific integrated circuits (ASICs), or field programmable gate arrays (FPGAs).

In some embodiments, the processing units in processing subsystem 704 can execute instructions stored in system memory 710 or on computer readable storage media 722. In various embodiments, the processing units can execute a variety of programs or code instructions and can maintain multiple concurrently executing programs or processes. At any given time, some or all of the program code to be executed can be resident in system memory 710 and/or on computer-readable storage media 722 including potentially on one or more storage devices. Through suitable programming, processing subsystem 704 can provide various functionalities described above. In instances where computer system 700 is executing one or more virtual machines, one or more processing units may be allocated to each virtual machine.

In certain embodiments, a processing acceleration unit 706 may optionally be provided for performing customized processing or for off-loading some of the processing performed by processing subsystem 704 so as to accelerate the overall processing performed by computer system 700.

I/O subsystem 708 may include devices and mechanisms for inputting information to computer system 700 and/or for outputting information from or via computer system 700. In general, use of the term input device is intended to include all possible types of devices and mechanisms for inputting information to computer system 700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Microsoft Kinect® motion sensor that enables users to control and interact with an input device, the Microsoft Xbox® 360 game controller, devices that provide an interface for receiving input using gestures and spoken commands. User interface input devices may also include eye gesture recognition devices such as the Google Glass® blink detector that detects eye activity (e.g., “blinking” while taking pictures and/or making a menu selection) from users and transforms the eye gestures as inputs to an input device (e.g., Google) Glass®. Additionally, user interface input devices may include voice recognition sensing devices that enable users to interact with voice recognition systems (e.g., Siri® navigator) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments and the like.

In general, use of the term output device is intended to include all possible types of devices and mechanisms for outputting information from computer system 700 to a user or other computer. User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. For example, user interface output devices may include, without limitation, a variety of display devices that visually convey text, graphics and audio/video information such as monitors, printers, speakers, headphones, automotive navigation systems, plotters, voice output devices, and modems.

Storage subsystem 718 provides a repository or data store for storing information and data that is used by computer system 700. Storage subsystem 718 provides a tangible non-transitory computer-readable storage medium for storing the basic programming and data constructs that provide the functionality of some embodiments. Storage subsystem 718 may store software (e.g., programs, code modules, instructions) that when executed by processing subsystem 704 provides the functionality described above. The software may be executed by one or more processing units of processing subsystem 704. Storage subsystem 718 may also provide a repository for storing data used in accordance with the teachings of this disclosure.

Storage subsystem 718 may include one or more non-transitory memory devices, including volatile and non-volatile memory devices. As shown in FIG. 7, storage subsystem 718 includes a system memory 710 and a computer-readable storage media 722. System memory 710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 700, such as during start-up, may typically be stored in the ROM. The RAM typically contains data and/or program modules that are presently being operated and executed by processing subsystem 704. In some implementations, system memory 710 may include multiple different types of memory, such as static random access memory (SRAM), dynamic random access memory (DRAM), and the like.

By way of example, and not limitation, as depicted in FIG. 7, system memory 710 may load application programs 712 that are being executed, which may include various applications such as Web browsers, mid-tier applications, relational database management systems (RDBMS), etc., program data 714, and an operating system 716. By way of example, operating system 716 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, Palm® OS operating systems, and others.

Computer-readable storage media 722 may store programming and data constructs that provide the functionality of some embodiments. Computer-readable media 722 may provide storage of computer-readable instructions, data structures, program modules, and other data for computer system 700. Software (programs, code modules, instructions) that, when executed by processing subsystem 704 provides the functionality described above, may be stored in storage subsystem 718. By way of example, computer-readable storage media 722 may include non-volatile memory such as a hard disk drive, a magnetic disk drive, an optical disk drive such as a CD ROM, DVD, a Blu-Ray® disk, or other optical media. Computer-readable storage media 722 may include, but is not limited to, Zip® drives, flash memory cards, universal serial bus (USB) flash drives, secure digital (SD) cards, DVD disks, digital video tape, and the like. Computer-readable storage media 722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs.

In certain embodiments, storage subsystem 718 may also include a computer-readable storage media reader 720 that can further be connected to computer-readable storage media 722. Reader 720 may receive and be configured to read data from a memory device such as a disk, a flash drive, etc.

In certain embodiments, computer system 700 may support virtualization technologies, including but not limited to virtualization of processing and memory resources. For example, computer system 700 may provide support for executing one or more virtual machines. In certain embodiments, computer system 700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 700. Accordingly, multiple operating systems may potentially be run concurrently by computer system 700.

Communications subsystem 724 provides an interface to other computer systems and networks. Communications subsystem 724 serves as an interface for receiving data from and transmitting data to other systems from computer system 700. For example, communications subsystem 724 may enable computer system 700 to establish a communication channel to one or more client devices via the Internet for receiving and sending information from and to the client devices. For example, the communication subsystem may be used to obtain table of data for the bulk file processing.

Communication subsystem 724 may support both wired and/or wireless communication protocols. For example, in certain embodiments, communications subsystem 724 may include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.XX family standards, or other mobile communication technologies, or any combination thereof), global positioning system (GPS) receiver components, and/or other components. In some embodiments communications subsystem 724 can provide wired network connectivity (e.g., Ethernet) in addition to or instead of a wireless interface.

Communication subsystem 724 can receive and transmit data in various forms. For example, in some embodiments, in addition to other forms, communications subsystem 724 may receive input communications in the form of structured and/or unstructured data feeds 726, event streams 728, event updates 730, and the like. For example, communications subsystem 724 may be configured to receive (or send) data feeds 726 in real-time from users of social media networks and/or other communication services such as Twitter® feeds, Facebook® updates, web feeds such as Rich Site Summary (RSS) feeds, and/or real-time updates from one or more third party information sources.

In certain embodiments, communications subsystem 724 may be configured to receive data in the form of continuous data streams, which may include event streams 728 of real-time events and/or event updates 730, that may be continuous or unbounded in nature with no explicit end. Examples of applications that generate continuous data may include, for example, sensor data applications, financial tickers, network performance measuring tools (e.g. network monitoring and traffic management applications), clickstream analysis tools, automobile traffic monitoring, and the like.

Communications subsystem 724 may also be configured to communicate data from computer system 700 to other computer systems or networks. The data may be communicated in various different forms such as structured and/or unstructured data feeds 726, event streams 728, event updates 730, and the like to one or more databases that may be in communication with one or more streaming data source computers coupled to computer system 700.

Computer system 700 can be one of various types, including a handheld portable device (e.g., an iPhone® cellular phone, an iPad® computing tablet, a PDA), a wearable device (e.g., a Google Glass® head mounted display), a personal computer, a workstation, a mainframe, a kiosk, a server rack, or any other data processing system. Due to the ever-changing nature of computers and networks, the description of computer system 700 depicted in FIG. 7 is intended only as a specific example. Many other configurations having more or fewer components than the system depicted in FIG. 7 are possible. Based on the disclosure and teachings provided herein, a person of ordinary skill in the art will appreciate other ways and/or methods to implement the various embodiments.

Although specific embodiments have been described, various modifications, alterations, alternative constructions, and equivalents are possible. Embodiments are not restricted to operation within certain specific data processing environments, but are free to operate within a plurality of data processing environments. Additionally, although certain embodiments have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described embodiments may be used individually or jointly.

Further, while certain embodiments have been described using a particular combination of hardware and software, it should be recognized that other combinations of hardware and software are also possible. Certain embodiments may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the embodiments. However, embodiments may be practiced without these specific details. For example, well-known circuits, processes, algorithms, structures, and techniques have been shown without unnecessary detail in order to avoid obscuring the embodiments. This description provides example embodiments only, and is not intended to limit the scope, applicability, or configuration of other embodiments. Rather, the preceding description of the embodiments will provide those skilled in the art with an enabling description for implementing various embodiments. Various changes may be made in the function and arrangement of elements.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method comprising:
receiving, by a data processing system, a request to process transactions within a bulk file;
consolidating, by the data processing system, the transactions into batches based on one or more parameters used to define the transactions;
processing, by the data processing system at a batch level, a first set of exception validations for each of the batches to identify batches that satisfy or do not satisfy the first set of exception validations;
storing, by the data processing system, information for each of the batches that satisfies the first set of exception validations within a set of tables, wherein the tables cascade from a file level to a batch level to an individual transaction level using common keys that reflect a hierarchy;
processing, by the data processing system at an individual transaction level, a second set of exception validations for each of the transactions within the batches that satisfy the first set of exception validations in order to identify transactions that satisfy or do not satisfy the second set of exception validations, wherein Java Message Service (JMS) Queues implementing: (i) a Message-Driven Bean (MDB), and (ii) the set of tables, are used for the processing of the second set of exception validations at the individual transaction level;
collating, by the data processing system, each of the transactions into subsequent batches based on whether each of the transactions satisfies or does not satisfies the second set of exception validations, wherein a timer job implementing the set of tables is used to collate each of the transactions into the subsequent batches; and
accounting, by the data processing system at the individual transaction level, each of the transactions in the subsequent batches that satisfy the second set of exception validations.

2. The method of claim 1, wherein the one or more parameters are network, debit account, value date, transfer currency, charge account, or any combination thereof.

3. The method of claim 1, further comprising:
prior to processing the second set of exceptions validations, resolving, by the data processing system at the individual transaction level, a network associated with each of the transactions, wherein the JMS Queues implementing: (i) another MDB, and (ii) the set of tables, are used for the resolving the network at the individual transaction level; and
collating, by the data processing system, each of the transactions into consequent batches based on the one or more parameters used to define the transactions, wherein another timer job implementing the set of tables is used to collate each of the transactions into the consequent batches,
wherein the second set of exception validations are processed for each of the transactions within the consequent batches that satisfy the first set of exception validations.

4. The method of claim 3, wherein the set of tables comprise a first table, a second table, and a third table, wherein the first table provides a batch status for each of the batches, the second table provides a network status and validation status for each of the transactions, and the third table provides a batch status for each of the consequent batches.

5. The method of claim 4, wherein the JMS Queues implementing: (i) the another MDB, and (ii) the first table and the second table, are used for the resolving the network at the individual transaction level.

6. The method of claim 5, wherein the JMS Queues implementing: (i) the MDB, and (ii) the third table and the second table, are used for the processing of the second set of exception validations at the individual transaction level.

7. The method of claim 1, further comprising rejecting, by the data processing system at the individual transaction level, each of the transactions in the subsequent batches that do not satisfy the second set of exception validations.

8. A non-transitory computer-readable memory storing a plurality of instructions executable by one or more processors, the plurality of instructions comprising instructions that when executed by the one or more processors cause the one or more processors to perform operations comprising:
receiving, by a data processing system, a request to process transactions within a bulk file;
consolidating, by the data processing system, the transactions into batches based on one or more parameters used to define the transactions;
processing, by the data processing system at a batch level, a first set of exception validations for each of the batches to identify batches that satisfy or do not satisfy the first set of exception validations;
storing, by the data processing system, information for each of the batches that satisfies the first set of exception validations within a set of tables, wherein the tables cascade from a file level to a batch level to an individual transaction level using common keys that reflect a hierarchy;
processing, by the data processing system at an individual transaction level, a second set of exception validations for each of the transactions within the batches that satisfy the first set of exception validations in order to identify transactions that satisfy or do not satisfy the second set of exception validations, wherein Java Message Service (JMS) Queues implementing: (i) a Message-Driven Bean (MDB), and (ii) the set of tables, are used for the processing of the second set of exception validations at the individual transaction level;
collating, by the data processing system, each of the transactions into subsequent batches based on whether each of the transactions satisfies or does not satisfies the second set of exception validations, wherein a timer job implementing the set of tables is used to collate each of the transactions into the subsequent batches; and
accounting, by the data processing system at the individual transaction level, each of the transactions in the subsequent batches that satisfy the second set of exception validations.

9. The non-transitory computer-readable memory of claim 8, wherein the one or more parameters are network, debit account, value date, transfer currency, charge account, or any combination thereof.

10. The non-transitory computer-readable memory of claim 8, wherein the operations further comprise:
prior to processing the second set of exceptions validations, resolving, by the data processing system at the individual transaction level, a network associated with each of the transactions, wherein the JMS Queues implementing: (i) another MDB, and (ii) the set of tables, are used for the resolving the network at the individual transaction level; and
collating, by the data processing system, each of the transactions into consequent batches based on the one or more parameters used to define the transactions, wherein another timer job implementing the set of tables is used to collate each of the transactions into the consequent batches,
wherein the second set of exception validations are processed for each of the transactions within the consequent batches that satisfy the first set of exception validations.

11. The non-transitory computer-readable memory of claim 10, wherein the set of tables comprise a first table, a second table, and a third table, wherein the first table provides a batch status for each of the batches, the second table provides a network status and validation status for each of the transactions, and the third table provides a batch status for each of the consequent batches.

12. The non-transitory computer-readable memory of claim 11, wherein the JMS Queues implementing: (i) the another MDB, and (ii) the first table and the second table, are used for the resolving the network at the individual transaction level.

13. The non-transitory computer-readable memory of claim 12, wherein the JMS Queues implementing: (i) the MDB, and (ii) the third table and the second table, are used for the processing of the second set of exception validations at the individual transaction level.

14. The non-transitory computer-readable memory of claim 13, wherein the operations further comprise rejecting, by the data processing system at the individual transaction level, each of the transactions in the subsequent batches that do not satisfy the second set of exception validations.

15. A system comprising:
one or more processors;
a memory coupled to the one or more processors, the memory storing a plurality of instructions executable by the one or more processors, the plurality of instructions comprising instructions that when executed by the one or more processors cause the one or more processors to perform operations comprising:
receiving, by a data processing system, a request to process transactions within a bulk file;
consolidating, by the data processing system, the transactions into batches based on one or more parameters used to define the transactions;
processing, by the data processing system at a batch level, a first set of exception validations for each of the batches to identify batches that satisfy or do not satisfy the first set of exception validations;
storing, by the data processing system, information for each of the batches that satisfies the first set of exception validations within a set of tables, wherein the tables cascade from a file level to a batch level to an individual transaction level using common keys that reflect a hierarchy;
processing, by the data processing system at an individual transaction level, a second set of exception validations for each of the transactions within the batches that satisfy the first set of exception validations in order to identify transactions that satisfy or do not satisfy the second set of exception validations, wherein Java Message Service (JMS) Queues implementing: (i) a Message-Driven Bean (MDB), and (ii) the set of tables, are used for the processing of the second set of exception validations at the individual transaction level;
collating, by the data processing system, each of the transactions into subsequent batches based on whether each of the transactions satisfies or does not satisfies the second set of exception validations, wherein a timer job implementing the set of tables is used to collate each of the transactions into the subsequent batches; and
accounting, by the data processing system at the individual transaction level, each of the transactions in the subsequent batches that satisfy the second set of exception validations.

16. The system of claim 15, wherein the one or more parameters are network, debit account, value date, transfer currency, charge account, or any combination thereof.

17. The system of claim 15, wherein the operations further comprise:
prior to processing the second set of exceptions validations, resolving, by the data processing system at the individual transaction level, a network associated with each of the transactions, wherein the JMS Queues implementing: (i) another MDB, and (ii) the set of tables, are used for the resolving the network at the individual transaction level; and
collating, by the data processing system, each of the transactions into consequent batches based on the one or more parameters used to define the transactions, wherein another timer job implementing the set of tables is used to collate each of the transactions into the consequent batches,
wherein the second set of exception validations are processed for each of the transactions within the consequent batches that satisfy the first set of exception validations.

18. The system of claim 17, wherein the set of tables comprise a first table, a second table, and a third table, wherein the first table provides a batch status for each of the batches, the second table provides a network status and validation status for each of the transactions, and the third table provides a batch status for each of the consequent batches.

19. The system of claim 18, wherein the JMS Queues implementing: (i) the another MDB, and (ii) the first table and the second table, are used for the resolving the network at the individual transaction level.

20. The system of claim 19, wherein the JMS Queues implementing: (i) the MDB, and (ii) the third table and the second table, are used for the processing of the second set of exception validations at the individual transaction level.
